(19) United States
(12) Patent Application Publication
(10) Pub. No.: US 2014/0129553 A1
(43) Pub. Date: May 8, 2014

(54) Search Results Based on Velocity Vectors

(71) Applicant: Sriram Sankar, Palo Alto, CA (US)

(72) Inventor: Sriram Sankar, Palo Alto, CA (US)

(21) Appl. No.: 13/672,404

(22) Filed: Nov. 8, 2012

(51) Int. Cl. G06F 17/30

(52) U.S. Cl. CPC G06F 17/30283
USPC 707/724

(57) ABSTRACT

In one embodiment, a method includes receiving a search query from a mobile-client system, where the mobile-client system has a location and a velocity vector, identifying one or more objects corresponding to the query, and determining a score for each object based on the location and velocity vector of the mobile-client system.

### TECHNICAL FIELD

This disclosure generally relates to search engines and performing searches for objects.

### BACKGROUND

Search engines have become popular tools to identify and locate specific information on the Internet. A search engine is a computer program that, when queried for information, retrieves either related information or pointers to the location of related information, or both, by evaluating content stored in its search database. A key metric in evaluating the performance of search engines is relevance of the search results. Search engine developers are always striving to deliver search results that are relevant to the search query being processed. Consistent with this goal, there have been attempts to rank search results based on a number of different factors. One of the more popular ways to rank search results involves analyzing the location and frequency of keywords on a webpage. Another frequently used technique is analyzing how webpages link to each other.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

A mobile computing device—such as a smartphone, tablet computer, or laptop computer—may include functionality for determining its location, direction, or orientation, such as a Global Positioning System (GPS) receiver, compass, or gyroscope. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, in response to a search query from a mobile computing device of a user, a search engine may use location, velocity, and direction information associated with the mobile computing device to help generate customized search results for the user. For example, the user of the mobile computing device may transmit a search query to the search engine, along with location, velocity, and direction information. Using this information, the search engine may calculate an estimated trajectory or path for the user. The search engine may then generate search results that are relevant to the estimated future location of the user. For example, the search engine may generate search results referencing users or locations that are proximal to the user's current trajectory or path. Objects that have locations that are closer to the user's path may be determined to be more relevant to the user, and thus ranked more highly in the search results that are generated for the user compared to more distant objects.

### BRIEF DESCRIPTION OF THE DRAWINGS

FIG. 1 illustrates an example network environment associated with a social-networking system.

FIG. 2 illustrates an example social graph.

FIG. 3 illustrates an example map.

FIG. 4 illustrates an example method for generating search results based on a velocity vector.

FIG. 5 illustrates an example computer system.

### DESCRIPTION OF EXAMPLE EMBODIMENTS

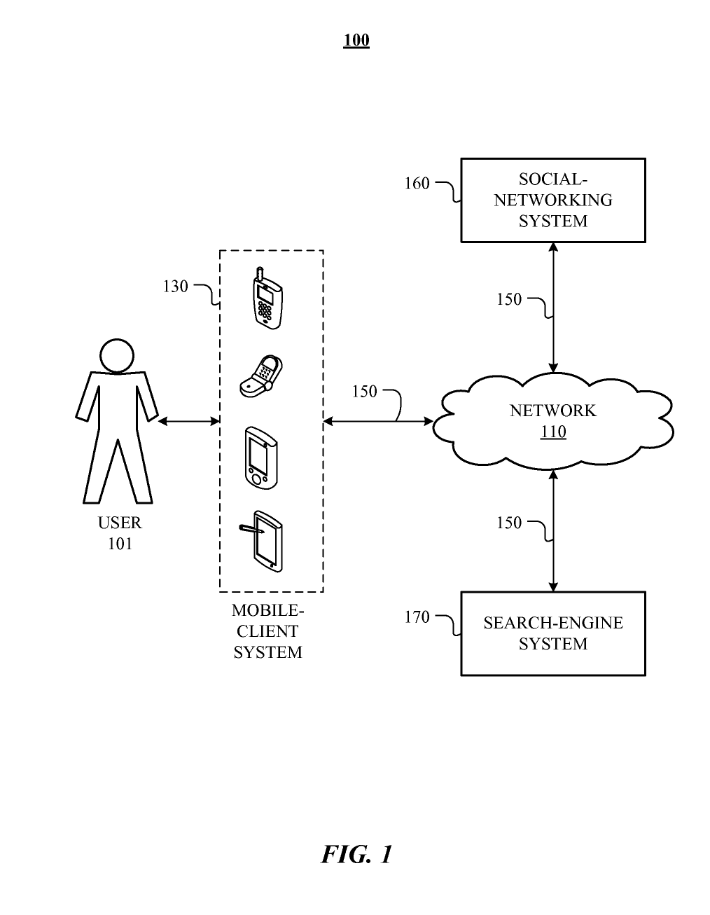

FIG. 1 illustrates an example network environment 100 associated with a social-networking system. Network environment 100 includes a user 101, a mobile-client system 130, a social-networking system 160, and a search-engine system 170 connected to each other by a network 110. Although FIG. 1 illustrates a particular arrangement of user 101, mobile-client system 130, social-networking system 160, search-engine system 170, and network 110, this disclosure contemplates any suitable arrangement of user 101, mobile-client system 130, social-networking system 160, search-engine system 170, and network 110. As an example and not by way of limitation, two or more of mobile-client system 130, social-networking system 160, and search-engine system 170 may be connected to each other directly, bypassing network 110. As another example and not by way of limitation, two or more of mobile-client system 130, social-networking system 160, and search-engine system 170 may be physically or logically co-located with each other in whole or in part. Thus, social-networking system 160 may be a sub-system of search-engine system 170, or vice versa. Moreover, although FIG. 1 illustrates a particular number of users 101, client systems 130, social-networking systems 160, search-engine systems 170, and networks 110, this disclosure contemplates any suitable number of users 101, client systems 130, social-networking systems 160, search-engine systems 170, and networks 110. As an example and not by way of limitation, network environment 100 may include multiple users 101, mobile-client system 130, social-networking systems 160, search-engine systems 170, and networks 110.

In particular embodiments, user 101 may be an individual (human user), an entity (e.g. an enterprise, business, or third-party application), or a group (e.g. of individuals or entities) that interacts or communicates with or over social-networking system 160. In particular embodiments, social-networking system 160 may be a network-addressable computing system hosting an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server that allows users 101 to opt in or opt out of having their actions logged by social-networking system 160 or shared with other systems (e.g. search-engine systems 170), such as, for example, by setting appropriate privacy settings. In particular embodiments, search-engine system 170 may be a network-addressable computing system that can host an online search engine. Search-engine system 170 may generate, store, receive, and send search-related data, such as, for example, search queries, search results, and other suitable search-related data. As an example and not by way of limitation, search-engine system 170 may implement one or more search algorithms to identify network resources in response to search queries received at search-engine system 170, one or more scoring algorithms or ranking algorithms to score and/or rank identified network resources, or one or more summarization algorithms to summarize identified network resources. In particular embodiments, a scoring algorithm implemented by search-engine system 170 may use a machine-learned scoring formula, which the scoring algorithm may obtain automatically from a set of training data constructed from pairs of search queries and selected Uniform Resource Locators (URLs), where appropriate. Search-engine system 170 may be accessed by the other components of network environment 100 either directly or via network 110. In particular embodiments, one or more users 101 may use one or more client systems 130 to access, send data to, and receive data from social-networking system 160 or search-engine system 170. Mobile-client system 130 may access social-networking system 160 or search-engine system 170 directly, via network 110, or via a third-party system. As an example and not by way of limitation, mobile-client system 130 may access search-engine system 170 via social-networking system 160. Mobile-client system 130 may be any suitable mobile computing device, such as, for example, a laptop computer, a cellular telephone, a smartphone, or a tablet computer.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect mobile-client system 130, social-networking system 160, and search-engine system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

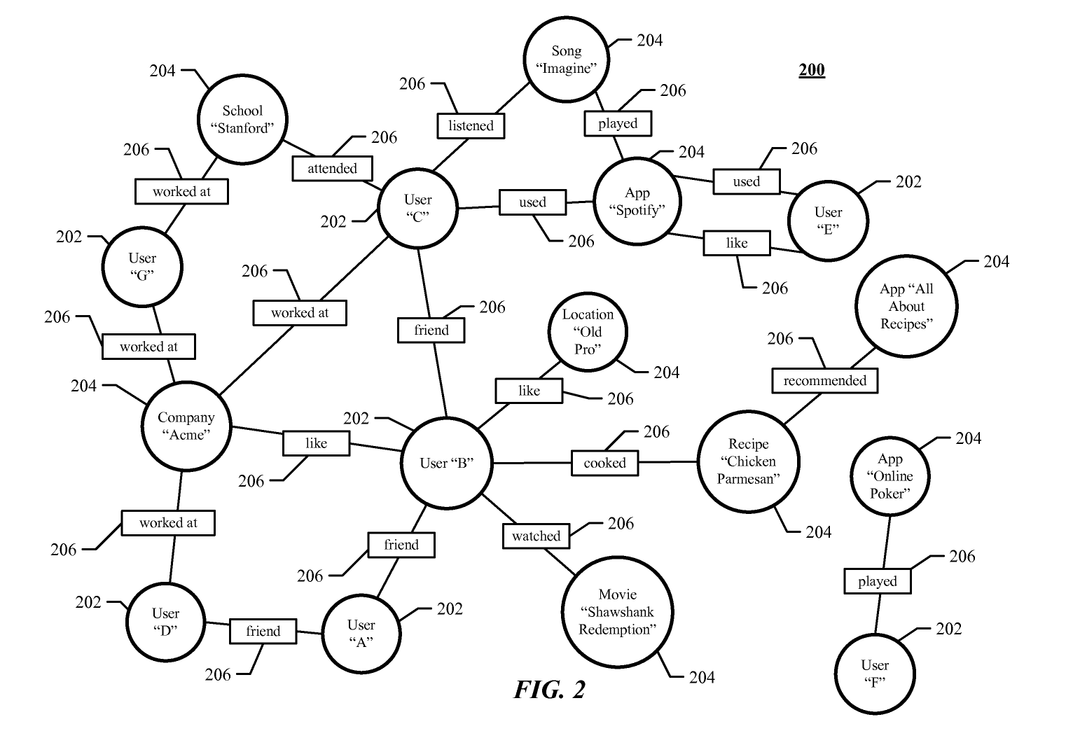

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, mobile-client system 130, or search-engine system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g. an enterprise, business, or third-party application), or a group (e.g. of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g. an image of the cover page of a book); a location (e.g. an address or a geographical location); a website (which may be associated with a URL); contact information (e.g. a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g. “eat”), causing a mobile-client system 130 to send to social-networking system 160 a message indicating the user's action. In response to the message, social-networking system 160 may create an edge (e.g. an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's mobile-client system 130) may indicate that he or she likes the concept represented by the concept node 204 by clicking or selecting a “Like” icon, which may cause the user's mobile-client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, the geographic location (hereinafter also simply “location”) of a mobile-client system 130 equipped with cellular, Wi-Fi, GPS, or other suitable capabilities may be identified with geographic-positioning signals. The geographic location of a place or venue (e.g., a local coffee shop) may be identified and stored as an address, a set of geographic coordinates (latitude and longitude), a reference to another location (e.g., “the coffee shop next to the train station”), or using another suitable identifier. In particular embodiments, the mobile-client system 130 may include one or more sensors that may facilitate geo-location functionalities of the system. Processing of sensor inputs by the mobile-client system 130 with one or more sensor devices (for example, processing a GPS sensor signal and displaying in the device's graphical user interface a map of a location corresponding to the GPS sensor signal) may be implemented by a combination of hardware, software, and/or firmware (or device drivers). As an example and not by way of limitation, geographic-positioning signals may be obtained by cell tower triangulation, Wi-Fi positioning, or GPS positioning. As another example and not by way of limitation, a geographic location of an Internet-connected computer can be identified by the computer's IP address. A mobile-client system 130 may also have additional functionalities incorporating geographic-location data of the device, such as, for example, providing driving directions, displaying a map of a current location, or providing information of nearby points of interest such as restaurants, gas stations, etc. As an example and not by way of limitation, a web browser application on the mobile-client system 130 may access a mapping library (e.g., via a function call) that generates a map containing a GPS location obtained by a device driver interpreting a GPS signal from a GPS sensor, and display the map in the web browser application's graphical user interface. Although this disclosure describes determining location in a particular manner, this disclosure contemplates determining location in any suitable manner.

In particular embodiments, a velocity vector of a mobile-client system 130 may be determined. A velocity vector describes the speed of an object and the direction of its motion. As an example and not by way of limitation, the location of a mobile-client system 130 may be identified over time. As the location of the mobile-client system 130 changes, the rate of change of its location may be used to determine the velocity of the mobile-client system 130. Similarly, the current location of the mobile-client system 130 may be compared to a prior location of the mobile-client system 130 to determine the direction of its motion. Although this disclosure describes determining velocity vectors in a particular manner, this disclosure contemplates determining velocity vectors in any suitable manner.

In particular embodiments, the mobile-client system 130 may automatically capture location, direction, and velocity data of the mobile-client system 130. This data may be captured by a special-purpose client application hosed on the mobile-client system 130, which may capture the data continuously, periodically, semi-periodically, in response to particular events, or at any other suitable time. The location, direction, and velocity data of the mobile-client system 130 may be transmitted to the social-networking system 160, the search-engine system 170, or another suitable system. Although this disclosure describes capturing particular data in a particular manner, this disclosure contemplates capturing any suitable data in any suitable manner.

In particular embodiments, the social-networking system 160 (or search-engine system 170, which may be physically or logically co-located with each other, as described previously) may maintain a database of information relating to geographic positions or places (hereinafter referred to collectively as “locations”). Locations may correspond to particular geographic coordinates (such as, for example, GPS coordinates), or to particular physical venues (such as, for example, parks, landmarks, restaurants, bars, train stations, airports, etc.). The social-networking system 160 may also maintain meta information about particular locations, such as, for example, photos of the location, advertisements, user reviews, comments, “check-in” activity data, “like” activity data, hours of operation, or other suitable information related to the location. In particular embodiments, a location may correspond to a concept node 204 in a social graph 200 (such as, for example, as described previously or as described in U.S. patent application Ser. No. 12/763,171, which is incorporated by reference herein). The social-networking system 160 may allow users to access information regarding a location using a client application (e.g., a web browser or other suitable application) hosted by a mobile-client system 130. As an example and not by way of limitation, social-networking system 160 may serve webpages (or other structured documents) to users that request information about a location. In addition to user profile and location information, the system may track or maintain other information about the user. As an example and not by way of limitation, the social-networking system 160 may support geo-social-networking functionality including one or more location-based services that record the user's location. As an example and not by way of limitation, users may access the geo-social-networking system using a special-purpose client application hosted by a mobile-client system 130 of the user (or a web- or network-based application using a browser client). The client application may automatically access GPS or other geo-location functions supported by the mobile-client system 130 and report the user's current location to the geo-social-networking system. In addition, the client application may support geo-social networking functionality that allows users to “check-in” at various locations and communicate this location to other users. A check-in to a given location may occur when a user is physically located at a location and, using a mobile-client system 130, access the geo-social-networking system to register the user's presence at the location. The social-networking system 160 may automatically checks in a user to a location based on the user's current location and past location data (such as, for example, as described in U.S. patent application Ser. No. 13/042,357 filed on Mar. 7, 2011, which is incorporated by reference herein). In particular embodiments, the social-networking system 160 may allow users to indicate other types of relationships with respect to particular locations, such as “like,” “fan,” “worked at,” “recommended,” “attended,” or another suitable type of relationship. In particular embodiments, “check-in” information and other relationship information may be represented in the social graph 200 as an edge 206 connecting the user node 202 of the user to the concept node 204 of the location.

In particular embodiments, a user of a mobile-client system 130 may search for information relating to a specific subject matter (e.g., persons, places, content, or resources) by providing a short phrase describing the subject matter, often referred to as a “search query,” to a search engine. The search engine may conduct a search based on the query phrase using various search algorithms and generate search results that identify resources (e.g., webpages, content, or other information) that are most likely to be related to the search query. To conduct a search, a user may input or transmit a search query to the search engine, which may be hosted by a search-engine system 170. In response, the search engine may identify one or more resources that are likely to be related to the search query, which may collectively be referred to as a “search result” identified for the search query. The search results may be presented to the user, often in the form of a list of links on search-results webpage, each link being associated with a different webpage that contains some of the identified resources or content. In particular embodiments, each link in the search results may be in the form of a Uniform Resource Locator (URL) that specifies where the corresponding webpage is located and the mechanism for retrieving it. The user may then be able to click on the URL links to view the specific resources contained in the corresponding webpages as he wishes. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are relatively more relevant to the search query or to the user may be ranked higher than the resources that are relatively less relevant to the search query or the user. In particular embodiments, the search engine may limit its search to resources and content on the online social network. However, in particular embodiments, the search engine may also search for resources on other sources, such as third-party systems, the internet or World Wide Web, or other suitable sources.

In particular embodiments, the search-engine system 170 may use the location, velocity, and direction information associated with a mobile-client system 130 when generating search results in response to a search query received from the mobile-client system 130 of a first user. A user with a mobile-client system 130 may transmit a search query to the search-engine system 170. The user may be searching for particular objects (i.e., places or persons) or types of objects. In particular embodiments, the user may be a user of an online social network, and may be searching for locations or persons represented as social-graph entities on a social graph 200. Additionally, the mobile-client system 130 may also transmit location, velocity, and direction information to the search-engine system 170. Thus, the mobile-client system 130 may have a first location and a first velocity vector associated with it, which may be determined as described previously. The first location and first velocity vector may be transmitted with the search query, or separately. In particular embodiments, a user may opt in to this service, which causes the client application to automatically transmit location data of the user to the social-networking system 160 or the search-engine system 170. In this manner, the search-engine system 170 may track the mobile-client system 130's location (and thus, the user's location) and provide search results that are customized for the user based on the user's current location and velocity vector. As an example and not by way of limitation, the search-engine system 170 may generate search results referencing users or locations that are proximal to the user's current trajectory or path. Although this disclosure describes generating particular search results based on particular location, velocity, and direction data in a particular manner, this disclosure contemplates generating any suitable search results based on any suitable location, velocity, or direction data in any suitable manner.

In particular embodiments, the search-engine system 170 may identify one or more objects corresponding to the query from the mobile-client system 130. In this context, an object may refer to a place or a person (such as, for example, another user of the online social network). Each object may be associated with a second location. Also, in the case of objects that are persons, the object may also be associated with a second velocity vector. In other words, the person may also be moving, and the location and velocity vector of that person may be determined analogously to the first user, as described previously. As an example and not by way of limitation, the first user may input the query “show me the nearest gas station.” The search-engine system 170 may parse this text query (such as, for example, by identifying one or more n-grams and identifying corresponding objects and search filters), and search for gas stations located near the first location of the user. Although this disclosure describes identifying particular objects corresponding to particular search queries, this disclosure contemplates identifying any suitable objects corresponding to any suitable search queries.

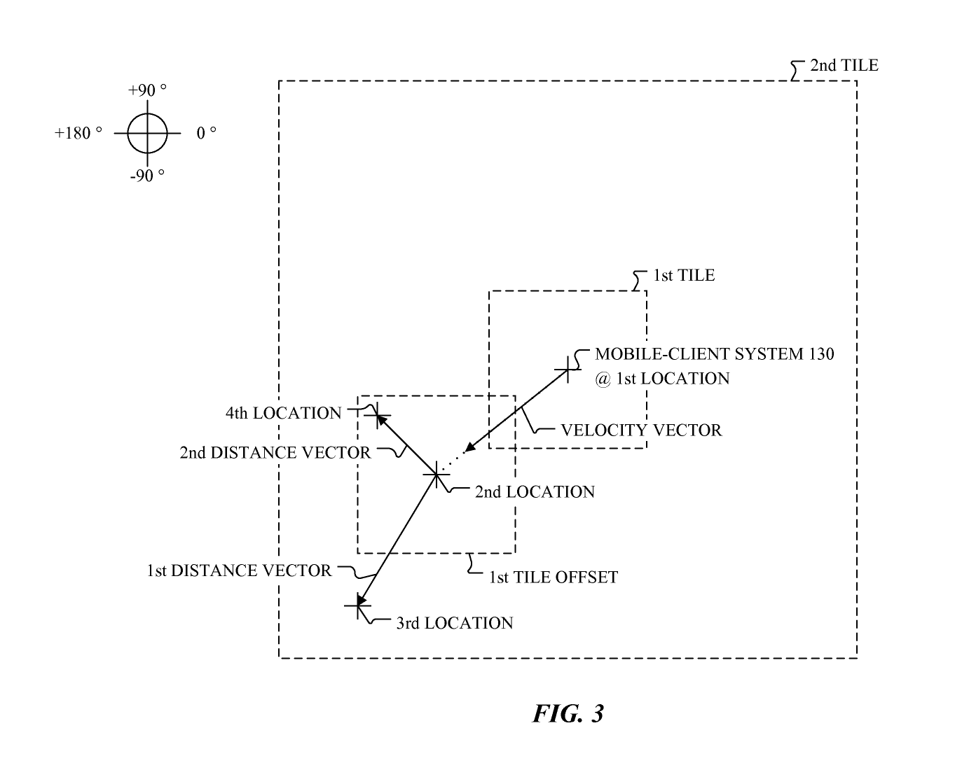

FIG. 3 illustrates an example map. In particular embodiments, the search-engine system 170 may determine a score for each identified object corresponding to the search query based on the first location and the first velocity vector of the mobile-client system 130. As the mobile-client system 130, and thus the user, travels in the direction of its velocity vector, the user may move closer to some objects and more distant from others. When searching for particular objects or object types, the user may be more interested in locating objects that are along the user's path rather than objects that are out of the way. In other words, the user may be more interested in finding objects that are ahead of the user rather than behind the user. Thus, objects that are proximal to the user's current trajectory or path may be scored more highly than objects that are more distant from the user's path. Although this disclosure describes and FIG. 3 illustrates particular systems and objects having particular locations and vectors, this disclosure contemplates any suitable systems and objects having any suitable locations and vectors. Moreover, although this disclosure describes determining scores for objects in a particular manner, this disclosure contemplates determining scores for objects in any suitable manner.

In particular embodiments, the search-engine system 170 may calculate an estimated location of the mobile-client system 130 based on the current location and velocity vector of the mobile-client system 130. The user's path may be estimated to lie along a line in the same direction as the first velocity vector. This estimated location may correspond to where the search-engine system 170 calculates that the mobile-client system 130 will be at a specified future time point. As an example and not by way of limitation, referencing FIG. 3, a mobile-client system 130 of a first user is illustrated as being at the 1^{st} location and having the velocity vector illustrated. The velocity vector has a direction of approximately −141°. The 2^{nd} location illustrated represents the estimated geographic position of the mobile-client system 130 as a specified future time point, where the 2^{nd} location may be determined as described previously. As another example and not by way of limitation, if the user is moving north at 60 mph, and the future time point is 5 minutes, then the estimated location may be a point that is equal to (60 mph)*(5 minutes)=5 miles north of the current location of the user. In particular embodiments, the user's path may also be estimated based on additional information, such as directions provided by a navigation system. Although this disclosure describes calculating the estimated position of a moving system or object in a particular manner, this disclosure contemplates estimating the position of a moving system or object in any suitable manner.

In particular embodiments, the search-engine system 170 may then determine the location of each previously identified object that corresponds to the user's search query. The search-engine system 170 may access a location database that contains location information for each identified object. As an example and not by way of limitation, referencing FIG. 3, the 3^{rd} location and 4^{th} location illustrated represent the geographic positions of identified object corresponding to a query from the first user. The search-engine system 170 may also determine a distance vector for each identified object, where the distance vector describes the distance and direction of the object with respect to a particular point (such as, for example, the mobile-client system 130, or the future estimated position of the mobile-client system 130). As an example and not by way of limitation, referencing FIG. 3, a 1^{st} distance vector is illustrated going from the 2^{nd} location to the 3^{rd} location, where the 1^{st} distance vector has a direction of approximately −121°. A 2^{nd} distance vector is illustrated going from the 2^{nd} location to the 4^{th} location, where the 2^{nd} distance vector has a direction of approximately +135°. Furthermore, the 2^{nd} location is illustrated as being closer to the 4^{th} location than the 3^{rd} location. Although this disclosure describes calculating particular locations and distance vectors of objects in a particular manner, this disclosure contemplates calculating any suitable locations or distance vectors of objects in any suitable manner.

In particular embodiments, the search-engine system 170 may then score each identified object based on the location, direction, and velocity data associated with the mobile-client system 130 and the identified objects. Identified objects that are more proximal to the user may be scored more highly than objects that are more distant. In particular embodiments, the search-engine system 170 may score each identified object based on its distance from the first user's estimated future position. Objects having locations that are closer to the user's position may be scored more highly than more distant objects. As an example and not by way of limitation, referencing FIG. 3, the 4^{th} location is closer to the 2^{nd} location than the 3^{rd} location, and thus the object at the 4^{th} location may be scored more highly than the object at the 3^{rd} location by the search-engine system 170. In particular embodiments, the search-engine system 170 may score each identified object based on its distance vector with respect to the first user's velocity vector. Objects having locations that are closer to the user's path or destination may be scored more highly then more distant objects. As an example and not by way of limitation, referencing FIG. 3, the 1^{st} direction vector, which has a direction of approximately −121°, is closer to the velocity vector of the first user, which has a direction of approximately −141°, than the 2^{nd} direction vector, which has a direction of approximately +135°. In other words, because the 3^{rd} location is closer to the estimated path of the first user, an object at the 3^{rd} location may be scored more highly than an object at the 4^{th} location, which is relatively out of the way of the path of the first user. In particular embodiments, where one or more of the identified objects is mobile (e.g., a person), the search-engine system 170 may score each identified object based on its velocity vector with respect to the first user's velocity vector. In this case, the search-engine system 170 may calculate future estimated positions for the mobile objects, and objects that have future estimated positions that are closer to the first user's path or destination may be scored more highly than more distant objects, or objects with velocity vectors that are moving them away from the first user. Although this disclosure describes determining particular scores in a particular manner, this disclosure contemplates determining any suitable scores in any suitable manner.

In particular embodiments, a map may represent geographic areas as map tiles (hereinafter simply “tiles”). Thus, particular locations may be associated with particular tiles of a map. Tiles may be fixed, or they may be dynamically defined, such as, for example, based on location of the map being viewed or accessed. In the example illustrated in FIG. 3, a 1^{st} and 2^{nd} tile are defined, where the mobile-client system 130 of the first user is located in the 1^{st} tile. The 2^{nd} tile is a concentric region that encompasses the 1^{st} tile. In particular embodiments, the search-engine system 170 may score objects in proximate tiles higher than objects in more distant tiles. As an example and not by way of limitation, if the querying user is in the 1^{st} tile, then objects in the 1^{st} tile may be scored more highly than objects that are in the 2^{nd} tile but beyond the 1^{st} tile. In particular embodiments, the search-engine system 170 may score objects with respect to a tile based on the future estimated location of the mobile-client system 130. As an example and not by way of limitation, if the querying user is at the 1^{st} location and has a velocity vector as illustrated, then the search-engine system 170 may identify an alternate tile, illustrated as the 1^{st} tile offset in FIG. 3, based on the 2^{nd} location. Thus, objects that are more proximate to the 1^{st} tile offset may be scored more highly. Consequently, objects that are in the 1^{st} tile, where the mobile-client system 130 is currently, may be scored lower than objects outside the 1^{st} tile but inside the 1^{st} tile offset. Although this disclosure describes and FIG. 3 illustrates particular maps with particular tiles, this disclosure contemplates any suitable maps having any suitable tiles. Moreover, although this disclosure describes scoring particular objects based on tiles in a particular manner, this disclosure contemplates scoring any suitable objects based on tiles in any suitable manner.

In particular embodiments, the search-engine system 170 may determine the score for an identified object based social-graph information corresponding to the object. A particular object may correspond to a social-graph entity, such as, for example, a user node 202 or a concept node 204. Thus, in response to a search query, the search-engine system 170 may access a social graph 200 on the social-networking system 160. The search-engine system 170 may then identify user nodes 202 or concept nodes 204 that correspond to the first query. The search-engine system 170 may then determine a score for the identified objects based on the social-graph information corresponding to those objects. As an example and not by way of limitation, when determining a score, s, for an object that corresponds to a search query, the calculation of the score may also factor in social-graph information. Thus, the score determined for a particular social-graph entity, k, given a particular search query, X, and social-graph information, G, may be calculated as s=(k|X, G). In particular embodiments, the search-engine system 170 may score objects that are locations based on presence of one or more of the first user's social contacts at the location. As an example and not by way of limitation, the search-engine system 170 may access the social-networking system 160 and a location database containing location data of other users of the social-networking system 160, and identify one or more locations corresponding to the search query from the first user that one or more of the first user's first-degree friends are currently present at (e.g., based on location check-in data, GPS coordinates, or other location data). The search-engine system 170 may then score locations with one or more of the first user's first-degree friends currently present higher than other locations with none of the first user's first-degree friends currently present. As another example and not by way of limitation, the search-engine system 170 may identify one or more social contacts of the first user who are associated with the location, such as, for example, a social contact who had checked in previously to the location, a social contact who has reviewed or commented on the location, or otherwise interacted with the location. The social-engine system 170 may then score locations that are more closely associated with the social contacts of the first user higher than locations that are less associated with the first user's social contacts. In particular embodiments, the score for an identified object may be based on the degree of separation between the user node 202 of the first user and the particular social-graph entity corresponding to the identified object. Objects corresponding to social-graph entities that are closer in the social graph 200 to the querying user (i.e., fewer degrees of separation between the element and the first user's user node 202) may be given higher scores than social-graph entities that are further from the user (i.e., more degrees of separation). In particular embodiments, the search-engine system 170 may adjust the score for an object based on social proximity between the first user and a social-graph entity corresponding to the object. The search-engine system 170 may assign an affinity score to a first user's social contact based on the relationship between the first user and the contact. As an example and not by way of limitation, the search-engine system 170 may assign an affinity score of 1.0 if a social contact is the first user's immediate family member (e.g., parents, siblings), an affinity score of 0.8 if a social contact is the first user's first-degree friend, an affinity score of 0.7 if a social contact and the first user went to the same college during the same year. A system for measuring user affinity is described more generally in U.S. patent application Ser. No. 11/503,093, filed on Aug. 11, 2006, which is hereby incorporated by reference. In particular embodiments, the score for an identified object may be based on the number of edges 206 connected to the node corresponding to the node for that object. Objects corresponding to nodes with more connecting edges 206 may be more popular and more likely to be a target of a search query. As an example and not by way of limitation, if the concept node 204 for “Stanford, Calif.” is only connected by five edges while the concept node 204 for “Stanford University” is connected by five-thousand edges, when determining the score for objects corresponding to either of these nodes, the search-engine system 170 may determine that the object referencing the concept node 204 for “Stanford University” has a relatively higher score than an object corresponding to the concept node 204 for “Stanford, Calif.” because of the greater number of edges connected to the former concept node 204. Although this disclosure describes determining scores for particular objects based on particular social-graph information in a particular manner, this disclosure contemplates determining scores for any suitable objects based on any suitable social-graph information in any suitable manner.

In particular embodiments, the search-engine system 170 may determine the score for an identified object using the following algorithm: s=p(d)+q(G)+r(\vec{d}·\vec{v})+s(Y), where G is social-graph information (e.g., number of check-ins at the location), \vec{d} is the distance vector from the future estimated location of the mobile-client system 130 to the identified object, d is the absolute value of the distance vector, \vec{v} is the velocity vector of the mobile-client system 130, (\vec{d}·\vec{v}) is the dot product of the vectors, Y is a miscellaneous factor, and p, q, r, and s are weighted variable. Although this disclosure describes determining the score for an identified object in a particular manner, this disclosure contemplates determining the score for an identified object in any suitable manner.

In particular embodiments, the search-engine system 170 may determine the score for an identified object based on a search history associated with the first user (i.e., the querying user). Objects corresponding to particular webpages or social-graph entities that the first user has previously accessed may be more likely to be the target of the first user's search query. Thus, these objects may be given a higher score. As an example and not by way of limitation, if first user has previously visited the “Stanford University” webpage, when determining the score for objects in response to a query for “Stanford,” the search-engine system 170 may determine that the webpage corresponding to the school “Stanford University” has a relatively high score because the querying user has previously accessed the webpage for the school. Although this disclosure describes determining scores for particular objects based on particular search history information in a particular manner, this disclosure contemplates determining scores for any suitable objects based on any suitable search history information in any suitable manner.

In particular embodiments, the search-engine system 170 may determine the score for an identified object based on the operating hours associated with the object. A location may have particular operating hours that indicate when the location is open or otherwise available. As an example and not by way of limitation, if the operating hours associated with the object indicate that it is not available, it may be given a relatively low score compared to an object that is currently available. As another example and not by way of limitation, if the current location and velocity vector associated with the user indicate that the user will reach an object after its operating hours have passed, that object may be given a relatively low score compared to an object that will still be available when the user actually reaches the object.

In particular embodiments, the search-engine system 170 may store the previously determined scores for the identified objects and periodically update the scores in response to additional information transmitted by the mobile-client system 130 of the first user. As an example and not by way of limitation, the search-engine system 170 may update the score of one or more objects as the user continues to move. The mobile-client system 130 of the user may transmit updated location and/or velocity vector information to the search-engine system 170, and the search-engine system 170 may then determine new or modified scores for the objects based on this updated information. For example, objects that are getting closer to the user as the user continues to move may have their score increase, while objects that the user has already passed or are otherwise become more distant may have their score decrease. In this way, the search-engine system 170 may continue to provide the most relevant search results to the user. Although this disclosure describes updating scores for objects in a particular manner, this disclosure contemplates updates scores for objects in any suitable manner.

In particular embodiments, the search-engine system 170 may generate search results comprising references to one or more of the objects having a score greater than a threshold score. The threshold score may be set so that a particular number of references are included in the search results. As an example and not by way of limitation, the search-engine system 170 may generate search results comprising references to only the top-N scoring objects. The value of N may be determined manually by the user or set by the search-engine system 170. Additionally, the value of N may be based on the size of available local storage on the user's mobile-client system 130, the bandwidth available to transmit the search results to the mobile-client system 130, the size of the display screen on the mobile-client system 130, or based on other suitable factors. In particular embodiments, the search-engine system 170 may generate a ranked list of objects based on the scores determined for the objects. Objects with better (e.g., higher) scores may be ranked higher than objects with worse (e.g., lower) scores. In particular embodiments, the search-engine system 170 may generate search results where particular fractions of the generated search results have particular geographic proximities to the first user. A series of concentric regions may be used, with each increasing region comprising a greater fraction of the total generated search results. As an example and not by way of limitation, referencing FIG. 3, the search-engine system 170 may generate search results where 60% of the search results comprise references to objects located within the 1^{st} tile offset, 30% of the search results comprise references to objects located within the 2^{nd} tile but beyond the 1^{st} tile (i.e., 90% of the total results being within the 2^{nd} tile), and 10% of the search results comprise references to objects located beyond the 2^{nd} tile (i.e., 100% of the total results including global results). Although this disclosure describes generating particular search results in a particular manner, this disclosure contemplates generating any suitable search results in any suitable manner.

In particular embodiments, the search-engine system 170 may transmit the search results to the mobile-client system 130 from which the search query was received. The search results may be transmitted as a structured document, such as a webpage, an email, or another suitable document. These transmitted search results may then be displayed to the user on the mobile-client system 130. As an example and not by way of limitation, the search-engine system 170 may transmit a webpage to the mobile-client system 130 that includes a map displaying the location of the user and of various objects references in the search results. As another example and not by way of limitation, the search-engine system 170 may transmit a document listing references to the identified object, along with information about the objects, such that the street address and distance to the object with respect to the user. In particular embodiments, the search-engine system 170 may also transmit advertisements or other sponsored content to the mobile-client system 130 in response to the search query. The advertisements may be included in as part of the search results, or separately. The advertisements may correspond to one or more of the objects referenced in the search results. Although this disclosure describes transmitting particular search results in a particular manner, this disclosure contemplates transmitting any suitable search results in any suitable manner.

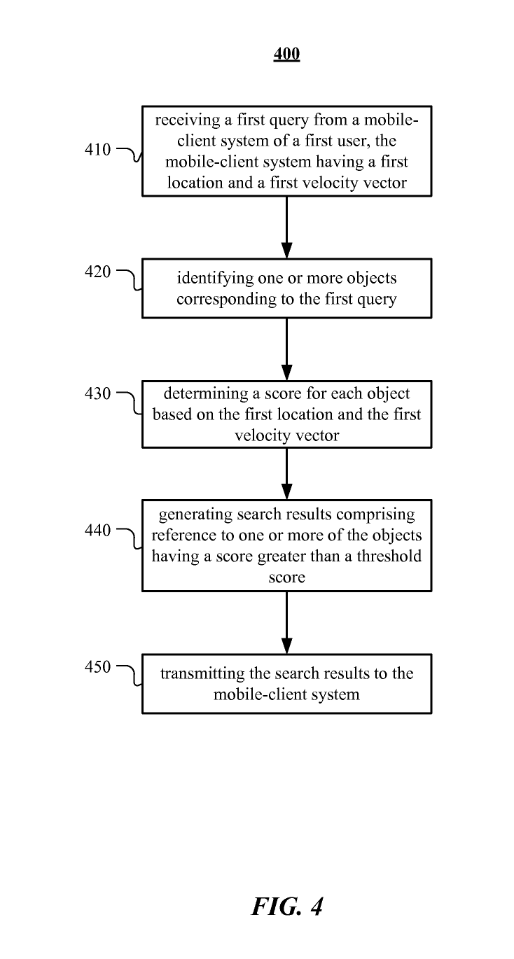

FIG. 4 illustrates an example method 400 for generating search results based on a velocity vector. The method may begin at step 410, where the search-engine system 170 may receive a first query from a mobile-client system 130 of a first user. The mobile-client system 130 may have a first location and a first velocity vector, which may be determined as described previously. At step 420, the search-engine system 170 may identify one or more objects corresponding to the first query. Each object may be associated with a particular second location. At step 430, the search-engine system 170 may determine a score for each object based on the first location and the first velocity vector. This score may be determined, for example, by calculating the estimated location of the mobile-client system 130 at some specified future time point and then determining the score based on the distance between the location of the object and the mobile-client system 130's estimated future position, as well as determining the score based on the relation between the distance vector to the location of the object and the velocity vector of the mobile-client system 130. At step 440, the search-engine system 170 may generate search results comprising references to one or more of the objects having a score greater than a threshold score. At step 450, the search-engine system 170 may transmit the search results to the mobile-client system 130. Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

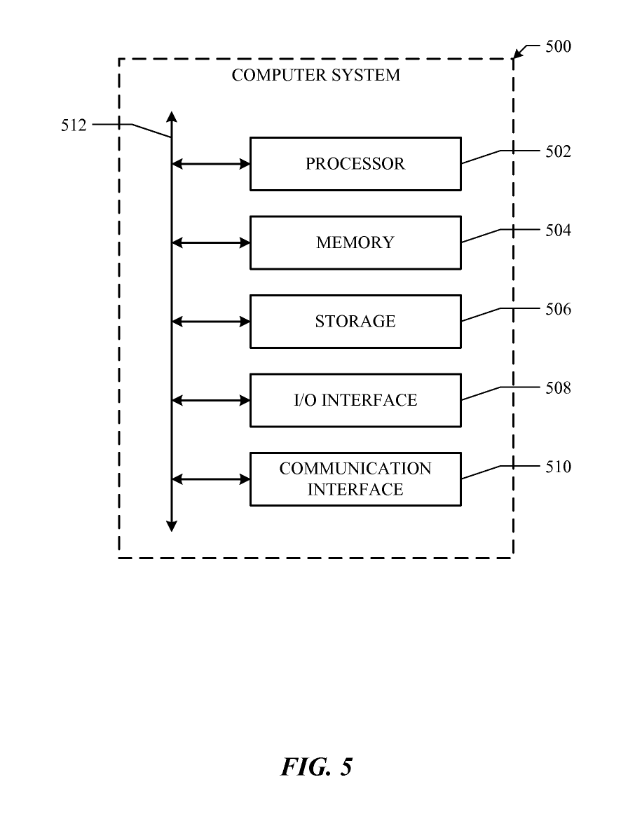

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by a computing device:
receiving a first query from a mobile-client system of a first user, the mobile-client system having a first location and a first velocity vector;
identifying one or more objects corresponding to the first query; and
determining a score for each object based on the first location and the first velocity vector.

2. The method of claim 1, further comprising:
generating search results comprising references to one or more of the objects having a score greater than a threshold score; and
transmitting the search results to the mobile-client system.

3. The method of claim 1, wherein each object is associated with a second location, and wherein determining the score for each object based on the first location and the first velocity vector comprises:
calculating a third location based on the first location and the first velocity vector, wherein the third location corresponds to an estimated geographic position of the mobile-client system at a specified future time point; and
determining the score for each object based on a distance between the third location and the second location associated with each object.

4. The method of claim 1, wherein each object is associated with a second location, and wherein determining the score for each object based on the first location and the first velocity vector comprises:
calculating a distance vector for each object, the distance vector for each object being a vector from the first location to the second location associated with the object; and
determining the score for each object based on an amount of the distance vector for the object that is in the same direction as the first velocity vector.

5. The method of claim 1, wherein each object is associated with a second location, and wherein determining the score for each object based on the first location and the first velocity vector comprises:
calculating a third location based on the first location and the first velocity vector, wherein the third location corresponds to an estimated geographic position of the mobile-client system at a specified future time point;
calculating, for each object, a distance vector from the third location to the second location associated with the object; and
determining the score for each object based on an amount the distance vector for the object that is in the same direction as the first velocity vector.

6. The method of claim 1, wherein the first location and the first velocity vector are received from the mobile-client system.

7. The method of claim 1, wherein the first location is based on one or more of a global position system (GPS) signal, a Wi-Fi signal, or a cellular radio signal.

8. The method of claim 1, further comprising:
accessing a social graph comprising a plurality of nodes and a plurality of edges connecting the nodes, each of the edges between two of the nodes representing a single degree of separation between them, the nodes comprising:
a first-user node corresponding to the first user, the first user being associated with an online social network; and
a plurality of second nodes that each correspond to a concept or a second user associated with the online social network, each second node being associated with a second location; and
wherein identifying one or more objects corresponding to the first query comprises identifying one or more second nodes corresponding to the first query.

9. The method of claim 8, wherein determining the score for each object based on the first location and the first velocity vector comprises:
calculating a third location based on the first location and the first velocity vector, wherein the third location corresponds to an estimated geographic position of the mobile-client system at a specified future time point; and
determining a score for each second node based on a distance between the third location and the second location associated with each second node.

10. The method of claim 8, wherein determining the score for each object is further based on the degree of separation between the first-user node and second node associated with the object.

11. The method of claim 1, wherein determining the score for each object is further based on a search history associated with the first user.

12. The method of claim 1, wherein each object is associated with an operating hours, and wherein determining the score for each object is further based on the operating hours associated with the object.

13. One or more computer-readable non-transitory storage media embodying software that is operable when executed to:
receive a first query from a mobile-client system of a first user, the mobile-client system having a first location and a first velocity vector;
identify one or more objects corresponding to the first query; and
determine a score for each object based on the first location and the first velocity vector.

14. A system comprising: one or more processors; and a memory coupled to the processors comprising instructions executable by the processors, the processors operable when executing the instructions to:
receive a first query from a mobile-client system of a first user, the mobile-client system having a first location and a first velocity vector;
identify one or more objects corresponding to the first query; and
determine a score for each object based on the first location and the first velocity vector.
